(19) United States
(12) Patent Application Publication
(10) Pub. No.: US 2022/0390229 A1
(43) Pub. Date: Dec. 8, 2022

(54) DEVICE AND METHOD FOR LIGHT-SUPPORTED DISTANCE DETERMINATION, CONTROL UNIT AND WORKING DEVICE

(71) Applicant: Robert Bosch GmbH, Stuttgart (DE)

(72) Inventor: Mirko Hattass, Stuttgart (DE)

(21) Appl. No.: 17/775,974

(22) PCT Filed: Dec. 11, 2020
(86) PCT No.: PCT/EP2020/085778

§ 371 Date: May 11, 2022

(30) Foreign Application Priority Data
Dec. 13, 2019 (DE) 10 2019 219 585.7

(51) Int. Cl. G01C 3/02

(52) U.S. Cl. CPC G01C 3/02

(57) ABSTRACT

A method for the light-supported distance determination of an object in a field of view. In the method: (i) the field of view is successively illuminated with primary light by a first and a second light source that differ with regard to a respective, in particular prespecified, intensity distance law, (ii) for each illumination, an intensity of secondary light reflected by the object from the field of view is quantitatively acquired by determining an intensity value that characterizes the respective intensity, (iii) the determined intensity values are set into relation to one another, in particular taking into account the respective intensity distance laws, and (iv) from the setting into relation, a value that is representative of a distance of the object is ascertained and/or provided.

### FIELD

The present invention relates to a device and a method for the light-supported distance determination of objects in a field of view, to a corresponding control unit, and to a correspondingly equipped working device as such, where the latter can be designed in particular as a vehicle or a robot.

### BACKGROUND INFORMATION

For environmental recognition of working devices, and in particular vehicles, increasingly so-called lidar (Light Detection and Ranging) systems are used, which are designed to send light or infrared radiation into a field of view, and to acquire and evaluate radiation reflected back from the field of view for the analysis of the field of view and for the detection of objects contained therein. In general, such systems are based on runtime measurements of light impulses, and therefore require a comparatively high outlay in terms of measurement technology, in particular with regard to the detectors and the evaluation mechanisms.

### SUMMARY

The method according to the present invention for light-supported distance determination may have, in contrast, the advantage that comparatively simple detector systems can be used, for example cameras having corresponding evaluation mechanisms. According to an example embodiment of the present invention, this is achieved in that a method is provided for the light-supported distance determination of an object in a field of view, in which:

(i) the field of view is successively illuminated with primary light by a first and a second light source that differ with regard to a respective, in particular prespecified, intensity distance law,

(ii) for each illumination, an intensity of secondary light reflected by the object from the field of view is quantitatively acquired by determining an intensity value that characterizes the respective intensity,

(iii) the determined intensity values are set into relation to one another, in particular taking into account the respective intensity distance laws, and

(iv) from this setting into relation, a value that is representative of a distance of the object is ascertained and/or provided.

The measures according to the present invention do not provide any complex flight time measurement, but rather are based on the evaluation and/or the comparison of intensities of received secondary light, and can therefore be realized with components that are technologically less complex.

Preferred developments of the present invention are disclosed herein.

In the method according to the present invention, according to a preferred development of the present invention particularly simple relations arise when, for or during the setting into relation, a quotient of measured intensity values is formed and is evaluated, in particular taking into account the respective intensity distance laws.

The procedure according to the present invention can further be realized with a comparatively low outlay if, according to another additional or alternative exemplary embodiment of the present invention, during or for the acquisition of an intensity by an image recording system, in particular with or from a camera device, an image of the field of view and/or of the object at a respective illumination is recorded.

In addition or alternatively, an image and/or particular parts, in particular pixels, thereof, of the field of view and/or of the object that are recorded can be evaluated in order to determine an intensity value.

Advantageously, ratios or quotients of values of individual pixels, a plurality of pixels, and/or of groups of pixels that correspond to one another in the various images can be formed. In the illumination of the field of view, and in particular of the object, various procedures result that can be carried out individually or can occur in combination with one another. Particularly simple optical relations arise if, for an illumination, a first light source is used that, in relation to the field of view, at least substantially follows an intensity distance law of a punctiform light source, and/or with a proportionality of 1/R².

Here, R designates the distance of the light source from an impingement point, and in particular the distance to the object from the light source.

In addition or alternatively, for a (possibly different) illumination a second light source can be used that, in relation to the field of view, at least substantially follows an intensity distance law of a rectilinear line-shaped light source and/or with a proportionality of 1/R, where R again designates the distance between the respective light source and an impingement point, and in particular the distance to the object, for the acquisition of the intensity.

According to an aspect that is optional, but that is relevant for an improvement of the functionality of the device according to the present invention, the camera can record an image of the scene without additional illumination in order to infer therefrom an intensity without illumination, I_without. In this way, an offset correction of the pixels or pixel regions can be carried out in order to reduce the influence of possible background light. In this connection, the intensities can be calculated for example in the sense of a norming equation

Q_corrected=(I_point−I_without)/(I_line−I_without),

where I_point designates the intensity of a pixel or of a pixel region in an image given illumination by a point source, I_line designates the intensity of a pixel or of a pixel region in an image given illumination by a line source, and Q_corrected designates the intensity ratio for the pixel or pixel region under consideration in an image given successive illumination by the point source and the line source, taking into account the ambient background light. From the intensity ratio Q_corrected, and taking into account corresponding prior factors if appropriate, the distance of the object belonging to the pixel region can then be inferred.

The taking into account of the background light can of course be generalized to more general light sources LQ1 and LQ2, for example according to an analogous definition of the variables Q_corrected, I_LQ1, I_LQ2, and I_without:

Q_corrected=(I_LQ1−I_without)/I_LQ2−I_without).

The individual light sources can be differently constructed.

Thus, according to an advantageous development of the present invention, it is possible for a light source, in particular as a second light source, to be used that has a plurality of sub-light sources, such that during operation the action of the light source is synthesized by the action of the sub-light sources.

In the end, the sub-light sources work together as a totality, and outwardly form an overall light source.

In addition or alternatively, a light source that is used, in particular as the second light source, can be fashioned in the manner of a line-shaped bar light source formed from a plurality of punctiform light sources, and in particular having a finite extension.

The first light source and the second light source can be formed from a common higher-order light source having a plurality of sub-light sources.

During operation, through the selection and/or controlling of the operation of the sub-light sources, the respective intensity distance laws for the first light source and/or for the second light source can then be implemented and set.

In a specific example embodiment of the method according to the present invention, during the setting into relation an angular correction is carried out that takes into account and/or corrects a lateral distance of the object relative to the system made up of the first and second light source.

Here, given the use of a punctiform light source and a rectilinear line-shaped light source, the angular correction for the intensity for the punctiform light source can be done using a correction factor of the form sqrt(R²+d²).

In this case, R designates the distance of the object from the line-shaped light source, d designates the lateral distance of the object from the punctiform light source along a direction of extension of the line-shaped light source, and sqrt designates the formation of the square root from the value after it in brackets.

For reasons of safety, namely so that passersby will not be irritated by the measurement processes, in another advantageous development of the method according to the present invention infrared light sources, whose radiation is not visually perceived by humans, are used as light sources.

In addition, the present invention also relates to a control unit for a device for the light-supported distance determination of an object in a field of view. In accordance with an example embodiment of the present invention, this control unit is set up to initiate, cause to run, carry out, control, and/or regulate a method according to the present invention for the light-supported distance determination of an object in a field of view.

In addition, the present invention also provides a device for the light-supported distance determination of an object in a field of view. This device is set up to initiate, cause to run, carry out, control, and/or regulate a method according to the present invention for the light-supported distance determination of an object in a field of view.

Advantageously, the device in accordance with an example embodiment of the present invention is fashioned having:
two light sources that differ with respect to a respective, in particular prespecified, intensity distance law, and that are set up to successively illuminate the field of view with primary light,
an image recording system and/or a camera that is or are set up to acquire an image of the object for each illumination by secondary light reflected from the field of view, and
a control unit realized according to the present invention. Finally, the present invention also provides a working device that is fashioned having a device realized according to the present invention for the light-supported distance determination of objects and that is used to monitor the environment of the working device.

In this context, the working device can be realized as a vehicle, as a robot, as a console, and/or as a monitoring device, in particular in a building, site, or the like.

### BRIEF DESCRIPTION OF THE DRAWINGS

Specific embodiments of the present invention are now described in detail with reference to the figures.

FIGS. 1 and 2 schematically show, in a lateral view, the use of a specific embodiment of the device according to the present invention for the light-supported distance determination of an object in a field of view, using the method according to the present invention, with a focus on a first, or on a second, illumination process.

FIG. 3 shows a variant of a line light source synthesized by point sources.

FIGS. 4 through 8 schematically show, in a lateral view, more specific cases of application of the design according to the present invention for the light-supported distance determination of an object in a field of view.

FIGS. 9 and 10 schematically show, in a lateral view, the design and the use of conventional lidar systems based on a scanning design or on a flash design.

### DETAILED DESCRIPTION OF EXAMPLE EMBODIMENTS

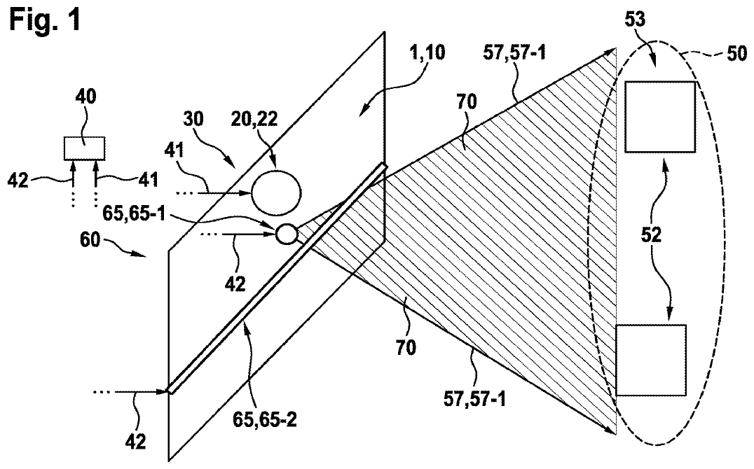

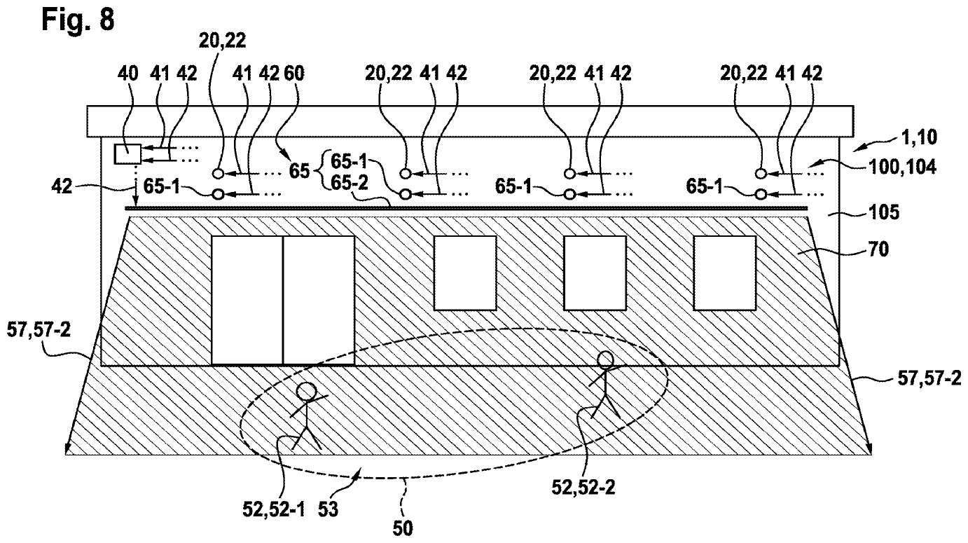

In the following, exemplary embodiments of the present invention and its technical background are described in detail with reference to FIGS. 1 through 10. Identical and equivalent elements and components, as well as those having identical or equivalent function, are designated by the same reference characters. The detailed description of the designated elements and components is not repeated every time they occur.

The depicted features and further properties can be isolated from one another in any form and combined with one another in any way without departing from the core features of the present invention.

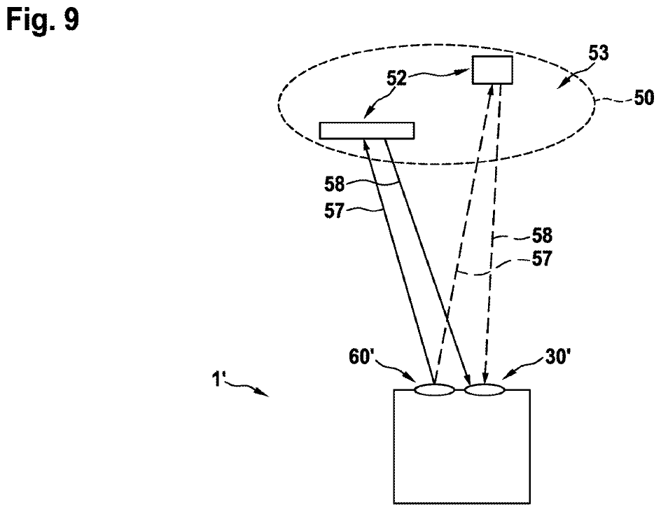

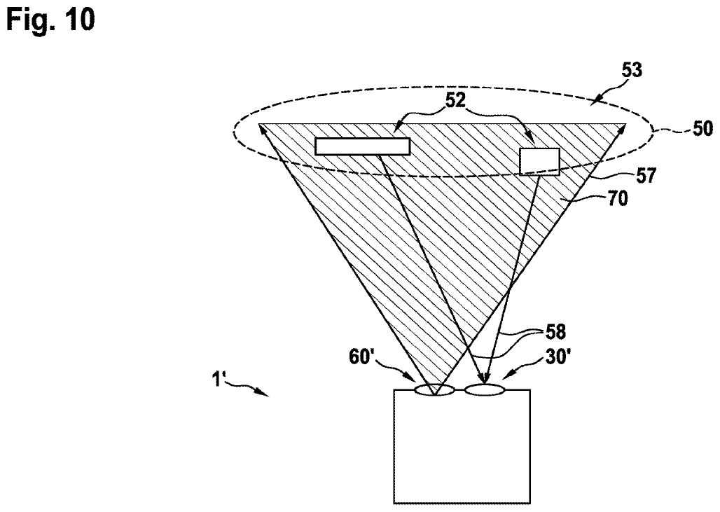

Conventional lidar systems 1′, as shown in FIGS. 9 and 10 for the scanning measurement design, or for the flash design, are used for distance measurement in various areas. These areas of use include, inter alia, industrial applications, automated driving, and, inter alia, military applications as well.

FIGS. 9 and 10 schematically show, in a lateral view, the design and the use of conventional lidar systems 1′ based on a scanning or flash design.

According to their core design, these lidar systems 1′ are based on a time-of-flight (ToF) measurement of light pulses. Here, a transmitter unit 60′ sends a short light pulse of primary light 57 into a field of view 50 of a scene 53 that has an object 52, and a suitable receiver unit 30′ acquires and records secondary light 58 coming from field of view 50, in particular a reflection of primary light 57 by objects 52.

Due to the large value of the speed of light, this measurement design places high demands on receiver unit 30′, and in particular on the detector technology on which it is based, in order to be able to record the pulse with a high time resolution. Conventionally, for this purpose technologies are used that are highly specialized and expensive, for example when compared to simple camera systems that cannot be used here.

In principle, there are further methods that are not based on direct runtime measurement, but rather for example on a modulation of the sent-out light intensity (indirect ToF) or light wavelength (FMCW).

These conventional methods likewise require specific detector technologies, but have advantages in accuracy, while on the other hand having disadvantages with regard to measurement speed.

An object of the present invention is to provide a method and a device 1 for light-supported distance measurement that do completely without a technically complicated time measurement, so that simple camera systems 22, or, in general, image acquisition devices 20, can be used as detectors.

A main feature of the present invention is the use of two different light sources 65-1 and 65-2 of a light source unit 65 as elements of a transmitter unit 60, one of the light sources 65-1 having a different characteristic in intensity dropoff over the distance R than does the other light source 65-2.

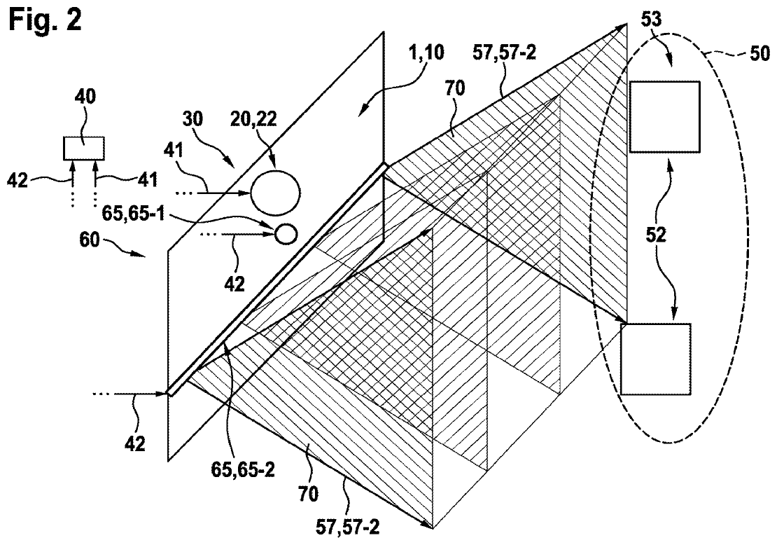

FIGS. 1 and 2 shows schematically, and in a lateral view, the use of a specific embodiment of the device 1 according to the present invention for the light-supported distance determination of an object 52 in a field of view 50 using the method according to the present invention, with focus on a first, or a second, illumination process, together with optical system 10 having receiver unit 30 and transmitter unit 60.

Specifically proposed is the use of a punctiform light source as first light source 65-1 and an elongated and/or bar-shaped light source as second light source 65-2 in a light source unit 65 of a transmitter unit or transmitter optical system 60 realized according to the present invention.

The advantages result from the omission of the time measurement and the omission of the technological challenges associated therewith.

In the corresponding receiver unit or receiver optical system 30, one or more simpler and lower-cost cameras 22 can be used in an image recording system 20 of receiver unit 30. Despite a large number of pixels, a comparatively high frame rate can be achieved with a low outlay.

Light sources that are used in conventional transmitter units 60′ in conventional lidar systems 1′ are typically point sources. That is, with the propagation of the light in space, the transmitted power is also distributed on the surface of a sphere.

Because the surface of the sphere having radius R increases as R², the power density dP/dA, in the sense of power per surface element at distance R, correspondingly decreases proportionally to 1/R². This also holds for a laser beam if the half-space after the beam waist is considered. An object 52 situated in the illuminated region of field of view 50 in turn also reflects into the space, or also back in the direction of transmitter 60/receiver 30. Here, each surface element can be regarded as a small point source that also radiates with the same 1/R² characteristic. The back-reflected power, which can be measured at receiver 30, is thus proportional to 1/R⁴.

A second used light source 65-2 having a different characteristic for the intensity dropoff with distance R can for example be a long bar-shaped light source, without requiring the use of particular optical systems, for example a fluorescent tube or a linear configuration of LEDs.

As an illustration, an infinitely long light source 65-2 can be considered.

The emitted power per length segment here is distributed not on spherical surfaces, but rather on cylinder surfaces. The surface of the cylinder however increases only proportionally to the distance R, so that the power density at an object in space is higher than in the case of a point source. This also results from Gauss's integral theorem.

Thus, the functional dependence of the light intensity at the distance R is here a proportionality of 1/R, where R here is the perpendicular distance to the extended light source 65-2. For the light 58 reflected by object 52 in field of view 50, again understood as the source of secondary light 58, the same conditions again hold as those for the point sources, so that overall a power level at receiver 30 arises that scales proportionally to 1/R³.

In order now to set up a distance measurement system, in general an image recording system 20, in particular a camera 22, as well as for example a punctiform first light source 65-1 of light source unit 65 of transmitter unit 60, as well as a bar-shaped second light source 65-2, are used.

For this purpose, the camera is preferably close to (i.e. the distance is small compared to the distances to be measured) the punctiform first light source 65-1 and the bar-shaped second light source 65-2, and is situated in the center.

Camera 22 can be based on CMOS, CCD, or other technologies.

According to FIG. 1, in a first step a camera image of scene 53 in field of view 50 having object 52 is produced, with illumination by first light source 65-1, the point source. An intensity value Iₚ can then be assigned to each pixel of the image, given point illumination.

According to FIG. 2, in a second step the scene 53, in field of view 50 having object 52, is then illuminated by second, bar-shaped light source 65-2, and a further image is produced by camera 22, or by the general image recording system 20. Here, an intensity value Iₛ, given bar illumination, is assigned to each pixel. If the ratio of the pixel values is now formed, from the intensity distance laws applying to the two light sources 65-1 and 65-2 there then results:

Iₛ/Iₚ=R⁴/R³=R.

The value of this ratio can in turn be assigned to the respective pixel.

In this way, it is possible, from the comparison and/or the calculation of intensity values of two exposures having different illumination, to determine the distance R to object 52 in field of view 50.

This functional relation at first holds exactly only for objects 52 at a perpendicular distance from the point source and bar source in space.

Objects 52 at a distance d lateral to point source 65-1 have a different functional dependence, because, going out from bar source 65-2, only the perpendicular distance R is relevant, while from point source 5 and 60-1 the geometrical sum sqrt(R²+d²) enters in.

However, the lateral distance can always be assigned to an angle and thus to a pixel. Therefore, through the application of an angular correction function the distance can also be indicated for the entire space.

The angular resolution of the system is limited only by the power of camera 22. The method is also independent of the reflection value or reflectivity value of the objects, because this goes as it were into the reflected power, and falls out in the formation of the ratio. Nonetheless, it is possible to determine the respective reflection capacity or the reflections of objects 52, by using the calculated distance for each pixel for the correction of the intensities e.g. of the image from the point illumination. For this purpose, the value Iₚ is multiplied by R².

For practical implementation, however, limits are placed on the system, because it is not the case that arbitrarily long light sources 65-2 can be used as bar light sources.

If the distance from light source 5 and 60-2 is very large compared to the length of light source 65-2, then the distance characteristic of bar source 65-2 again goes over to a 1/R² relation.

Thus, the limit for a distance determination is defined later by the dynamic range of the camera pixels that must acquire both the overall intensity for near and for far objects, and also the differences, with adequate accuracy.

For practical use, the system is designed for a non-visible wavelength (e.g., near infrared), and camera 22 is equipped with optical filters in order to suppress the background light.

In connection with the Figures, it is also to be mentioned that in a respective device for light-supported or light-based distance measurement relative to an object 52 in a scene 53 in a field of view 50, is still to be mentioned transmitter unit 60 and in particular light source unit 65 having light sources 65-1 and 65-2 as well as receiver unit 30 having image recording system 20 and camera 22 to be seen in effective connection, namely via first and second acquisition and/or control lines 41 or 42, with a higher-order control and/or evaluation unit 40 that is set up to initiate, to cause, to carry out, to control, and/or to regulate the method according to the present invention for light-based or light-supported distance measurement.

### Alternative Embodiments

Alternatively, the sequence of illumination by first and second light source 65-1 and 65-2 can be exchanged (and then correspondingly taken into account in the calculations).

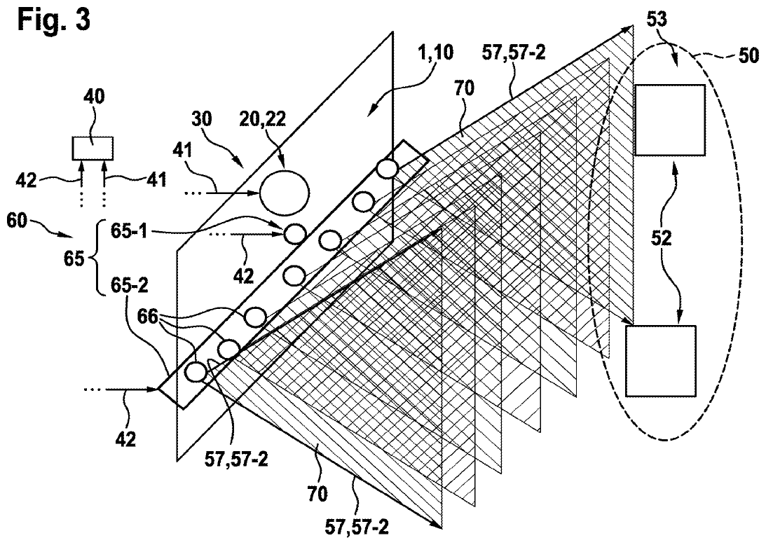

FIGS. 3 through 8 schematically show, in a lateral view, more specific cases of application of the design according to the present invention for the light-supported distance determination of an object 52 in a field of view 50.

Alternatively, according to FIG. 3, instead of a homogenous bar-shaped light source 65-2 as shown in FIGS. 1 and 2, the present invention can also be realized with distributed light sources 66, which can also be understood as sub-light sources.

The light from bar source 65-2 is thus composed of the light from individual sources or sub-light sources 66.

The functional dependence that then results of the power on the pixel can however here show a somewhat different functional relation than in the ideal case of illumination by cylindrical light source 65-2 in FIGS. 1 and 2. However, this can be compensated by corresponding corrective measures.

A deviation from the homogenous bar illumination can also be compensated by calibrating the pixel sensitivities.

In the extreme case, in this way an illumination by only two point sources can replace the cylindrical source.

In addition, it is also possible to use a cylindrical light source having a plurality of point sources and cameras.

In general, it is possible to use, instead of a bar source 62-2, a different light source that has a different functional relationship than 1/R² for the power density for the distance R.

This could be a differently extended source having a circular shape, or a completely different optical design. In this case, a significant deviation from the 1/R² functional relation of the emitted light would then also occur, which however nonetheless would still enable use for the near field.

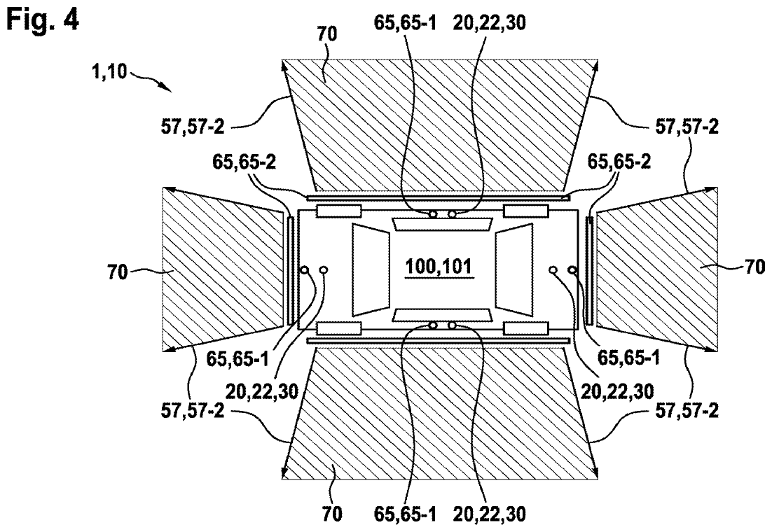

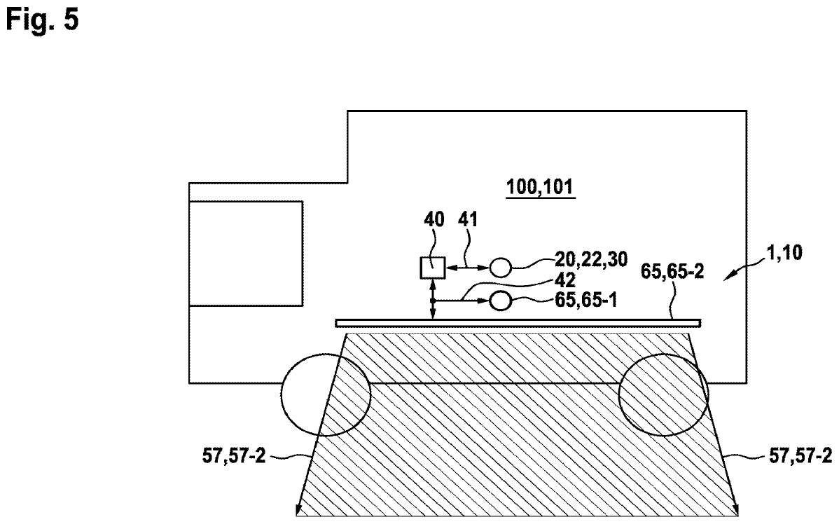

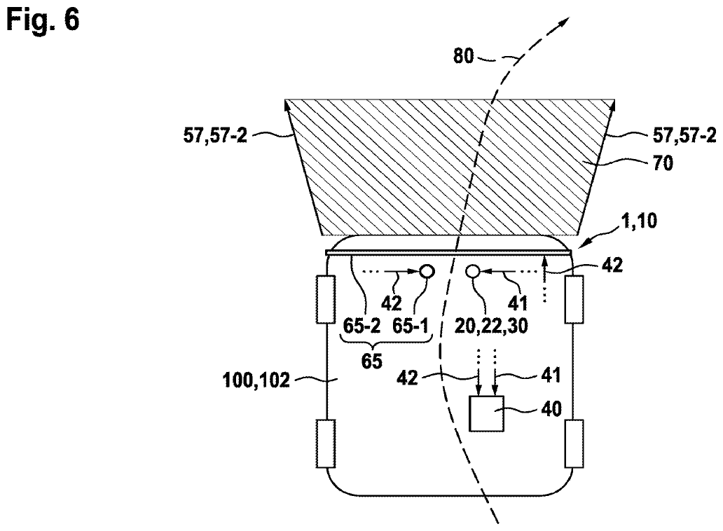

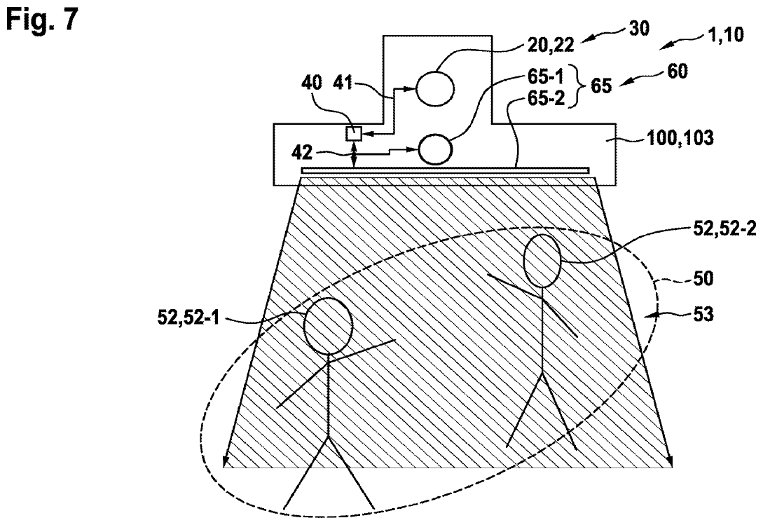

Depending on the size of extended light source 65-2, there are various possible applications, as shown in FIGS. 4 through 8.
(a) The present invention, understood as distance sensor 1, can for example be used in the near field in the technical area of motor vehicles, here for example as a lateral sensor, because here a long vehicle side is available. This is shown in FIGS. 4 and 5 for a passenger vehicle and for a truck, understood in each case as vehicle 101 taken as a basis.
(b) In robotics, the present invention can be used as a distance sensor for autonomous systems, for example for robots 102 for monitoring a travel course 80 according to FIG. 6, or as a human-machine interface, for example for game consoles 103 or for other input devices according to FIG. 7, and in particular in use with a plurality of persons 52-1 and 52-2, understood as objects 52 in scene 53 of field of view 50.
(c) In addition, the present invention can be used in building or security technology as monitoring system 104 on or in a building 105, in which approaching persons 52-1, 52-2, understood as objects 52 in a field of view 50 with scene 53, can be acquired and/or monitored in their distance from building 105.

1-10. (canceled)

11. A method for a light-supported distance determination of an object in a field of view, comprising the following steps:
(i) successively illuminating the field of view with primary light by a first and a second light source that differ with regard to a respective prespecified intensity distance law;
(ii) for each illumination, quantitatively acquiring a respective intensity of secondary light reflected by the object from the field of view by determining an intensity value that characterizes the respective intensity;
(iii) setting the determined intensity values into relation to one another taking into account the respective intensity distance laws; and
(iv) from the setting into the relation, ascertaining and/or providing a value that is representative of a distance of the object.

12. The method as recited in claim 11, wherein, for or during the setting into relation, a quotient is formed of the determined intensity values and is evaluated and/or compared taking into account the respective intensity distance laws.

13. The method as recited in claim 11, wherein during or for the acquisition of each respective intensity:
an image of the field of view and/or of the object is recorded by an image recording system and/or by or from a camera device; and/or
a recorded image of the field of view and/or of the object and/or pixels of the recorded image, is evaluated in order to determine the respective intensity value, ratios or quotients being formed of values of individual pixels, a plurality of pixels, or groups of pixels.

14. The method as recited in claim 11, wherein:
for an illumination, the first light source is used, the first light source being a light source that, in relation to the field of view follows, at least substantially, an intensity distance law of a punctiform light source, and/or with a proportionality of 1/R², and/or
for another illumination, the second light source is used, the second light source being a light source that, relative to the field of view at least substantially follows an intensity distance law of a rectilinear line-shaped light source and/or with a proportionality of 1/R;
where R is a distance between the respective light source and an impingement point of the acquisition of the intensity, and/or to the object.

15. The method as recited in claim 11, wherein:
the second light source has a plurality of sub-light sources; and/or
the second light source is a line-shaped bar light source formed from a plurality of punctiform light sources; and/or
the first light source and the second light source are formed by a common light source having a plurality of sub-light sources in which, through the selection and/or controlling of an operation of the sub-light sources, the respective illuminations, with the corresponding intensity distance laws, can be set for the first light source and for the second light source.

16. The method as recited in claim 11, wherein one of the first and second light sources is a punctiform light source, and the other of the first and second light sources is a rectilinear line-shaped light source, and wherein, during the setting into the relation, an angular correction is carried out that takes into account and/or corrects a lateral distance of the object relative to the system of the first and second light source, in which, the angular correction, given an intensity for the punctiform light source, takes place using a correction factor having the form sqrt(R2+d²), where R designates a distance of the object from the line-shaped light source and d designates a lateral distance of the object from the punctiform light source along a direction of extension of the line-shaped light source, and sqrt designates formation of a square root.

17. The method as recited in claim 11, wherein the first and second light sources are infrared light sources.

18. A control unit for a device for a light-supported distance determination of an object in a field of view, the control unit configured to:
(i) successively illuminate the field of view with primary light using a first and a second light source that differ with regard to a respective prespecified intensity distance law;
(ii) for each illumination, quantitatively acquire a respective intensity of secondary light reflected by the object from the field of view by determining an intensity value that characterizes the respective intensity;
(iii) set the determined intensity values into relation to one another taking into account the respective intensity distance laws; and
(iv) from the setting into the relation, ascertain and/or provide a value that is representative of a distance of the object.

19. A device for a light-supported distance determination of an object in a field of view, comprising:
two light sources that differ with regard to a respective prespecified, intensity distance law, and that are set up to successively illuminate the field of view with primary light;
an image recording system and/or a camera that is configured to acquire, for each illumination by secondary light reflected from the field of view, an image of the object; and
a control unit configured to:
(i) successively illuminate the field of view with the primary light using the first and a second light source;
(ii) for each illumination, quantitatively acquire a respective intensity of secondary light reflected by the object from the field of view by determining an intensity value that characterizes the respective intensity;
(iii) set the determined intensity values into relation to one another taking into account the respective intensity distance laws; and
(iv) from the setting into the relation, ascertain and/or provide a value that is representative of a distance of the object.

20. A working device for monitoring an environment of the working device, the working device being a vehicle, and/or a robot, and/or a console, and/or a monitoring device, the working device comprising a device for a light-supported distance determination of an object in a field of view, the device including:
two light sources that differ with regard to a respective prespecified, intensity distance law, and that are set up to successively illuminate the field of view with primary light;
an image recording system and/or a camera that is configured to acquire, for each illumination by secondary light reflected from the field of view, an image of the object; and
a control unit configured to:
(i) successively illuminate the field of view with the primary light using the first and a second light source;
(ii) for each illumination, quantitatively acquire a respective intensity of secondary light reflected by the object from the field of view by determining an intensity value that characterizes the respective intensity;
(iii) set the determined intensity values into relation to one another taking into account the respective intensity distance laws; and
(iv) from the setting into the relation, ascertain and/or provide a value that is representative of a distance of the object.
